(19) United States
(12) Patent Application Publication
(10) Pub. No.: US 2003/0014353 A1
(43) Pub. Date: Jan. 16, 2003

(54) System for letter of credit selector on internet exchange

(76) Inventor: Thomas E Fitzherbert, Ringwood, NJ (US)

Correspondence Address: NATH & ASSOCIATES, 1030 15th STREET, 6TH FLOOR, WASHINGTON, DC, 20005, US

(21) Appl. No.: 10/182,653

(22) PCT Filed: Feb. 1, 2001
(86) PCT No.: PCT/US01/03261

(51) Int. Cl. G06F 17/60

(52) U.S. Cl. 705/37

(57) ABSTRACT

A computer system using a global computer network such as the Internet to effect the selection of banks to issue and to confirm letters of credit. A website (15) is maintained by a transaction manager and receives requests for the issuance of an LC and the confirming of an LC from a buyer and a seller, respectively. The website also receives bids from LC issuers for an issuance request and from LC confirmers for a confirmation request and formats all of the bids into a formatted form and provides the buyer and the seller access to the formatted form. Upon successful agreement between a buyer and an LC issuer, the website charges each a fee for using the website, and upon successful agreement between a seller and an LC confirmer, the website charges each a fee for using the website.

### CROSS REFERENCE TO RELATED APPLICATION

This application claims the benefit of U.S. Provisional Application No. 60/179,430, filed Feb. 1, 2000 and entitled “L/C SELECTOR.COM INTERNET EXCHANGE,” which provisional application is incorporated in its entirety herein by reference.

### FIELD OF THE INVENTION

The present invention relates in general to a business method and computer system relating to an Internet site that permits a buyer to seek offers from a seller, and relates in particular to a secure Internet system that permits a customer to seek offers from participating providers in the banking industry.

### BACKGROUND OF THE INVENTION

Whenever international marketplaces grow exponentially, as they are growing in the digital marketplaces for the industrial sectors, there is a need for an efficient payment mechanism for commercial transactions. The present marketplace of letters of credit is over $120 billion per year.

Trade is growing rapidly due to free trade and privatizing state-run economics. Trade is cutting costs, but not always credit risk.

The problems begin after an exporter and importer have made a deal involving the sale of goods in one country and the importation of those goods in a second country. The problem now is how does payment get effected so that the exporter will release the goods knowing it will get paid and the importer will make the payment knowing the goods will be released.

Many of these emerging economies need basic financial payment/credit risk instruments to finance this trade. One such mechanism is a Letter of Credit, or LC. Buyers need to piggy-back LCs for payment on top of emerging e-procurement vertical exchanges arranged by major multinational suppliers. MNCs and medium sized businesses need to expedite sales and collections. Banks need more efficient exchange system to generate more efficient exchange system to generate more fee-based business, while managing credit risks to corporate exposure.

Traditional L/C problems will not be solved, but more expansive view of the marketplace battlefield will be visible for corporate strategic e-procurement, return on equity and banks' return on capital.

### SUMMARY OF THE INVENTION

The present invention comprises a business method and computer system relating to an Internet site that permits a customer to seek offers from participating issuers of Letters of Credit (LC), and then to select an offered LC commitment with the desired issuer. In a particular embodiment, the invention brings together sellers, buyers, issuing banks, and confirming banks through their own computers using secure or encrypted information over a global computer network, such as the Internet.

The present invention allows efficient intermediation of available or new credit sources, while generating new fee streams for banks, utilizing bank trade finance facilities more efficiently, and more cheaply. The use of an e-commerce interchange drives costs down, improves balance sheet/cash flow and ROE

The present, invention allows exporters, importers, and banks to select the most efficient conventional bank letter of credit to handle payments under contractual international sales of goods and services. Exporters can determine the full bank market availability for letter of credit confirmations, at the best commission rates.

Importers can select from a wider source of trade credit is than previously known, at the best cost. Banks which are actively buying or developing Internet based software products with which to offer to, and service, their customers, can use the present invention to enable them to use existing products, find new customers, and utilize used bank-to-bank credit facilities more efficiently from low cost, existing resources.

The present invention provides a first-to-market advantage with attendant efficiencies that can very profitably interact with and complement all exchanges with an efficient payment model. The present invention allows all international banks to use their own products, and trade partners to use existing LC documentation accessed securely through a website.

As a result of the present invention, business exchange is between exporters, importers and banks in all countries of the world. The exchange facilitates world trade through more efficient information exchange as to all available users and/or providers of LC's to complete trade payments under trade contracts and similar documents.

One embodiment of the present invention involves a plurality of steps. In a first step, the exporter and importer conclude a sales commitment involving a transaction in goods or services between the importer and exporter in any two or more countries, and information about the transaction is posted on the website of a manager or controller. In a second step, one or more participating opening banks access the website, read the transaction information, and if interested, post a confidential bid that only the importer can read. In a third step, the importer returns to the manager's website and selects one of the bids. In a fourth step, one or more confirming banks access the website, read the accessible posted information as released by the exporter about the transaction, and posts a confidential confirming bid for the LC for the exporter to consider.

In a fifth step, the exporter returns to the manager's website and selects one of the bids of the confirming banks to complete the LC transaction. In an optional sixth step, a confirmation of the LC transaction is sent and the bank transaction fees are transferred through the manager's website, with the manager receiving a commission.

These and other features and advantages of the present invention will be further discussed or apparent from the detailed description of the preferred embodiment section set forth hereinbelow.

### BRIEF DESCRIPTION OF THE DRAWING

The present invention will become better understood by reference to the following drawing which is a comprehensive system block diagram and flow chart showing five steps of a business model according to the present invention.

### DETAILED DESCRIPTION OF THE PREFERRED EMBODIMENT

The foregoing aspects and many of the attendant advantages of the present invention will become more readily appreciated from the following description of a presently preferred embodiment thereof with reference to the accompanying drawing.

Referring to the drawing, there is shown a system and method of selecting a Letter of Credit (LC) opening and/or confirming banks through a computer network such as a global computer network like the Internet. The system has five steps or stages and in the drawing, the flow of information for each step is indicated by a different-type of dashed or dotted line, each dashed or dotted line for convenience being identified by a color, as follows:

Step I (Transaction Posted): a dashed line consisting of a series of groups of two small, fine lines with an indicated color of link;

Step II (Issuing Banks Bid): a dashed line consisting of a series of small, thick dashes with an indicated color of green;

Step III (Importer Selects Issuing Bank): a solid dashed, thick line consisting with an indicated color of black;

Step IV (Confirmation Banks Bid): a dotted line consisting of a series dots with an indicated color of blue; and

Step V (Exporter Selects Confirmation Bank): a solid, thin line with an indicated color of red.

The shorthand title of each step is indicated in parenthesis.

As shown in the figure, there are five basic participants, each of which has a computer system that is connected to a computer network, such as a global computer network like the Internet. For ease of this description, each of the lines between the participants will be a communication on the Internet. The basic participants are: an Importer Computer System 10 which contains the importer's data for the transaction (IDT); an Exporter Computer System 12 which contains the exporter's data for the transaction (EDT); a central computer system of a L/C Selector Internet Exchange or transaction manager 14 which contains the computer software for a website 15; one or more participating issuing bank computer systems 16, three of which are depicted as Bank A numbered 16a, Bank B numbered 16b and Bank C numbered 16c; and one or more participating confirming bank computer systems 18, three of which are depicted as Bank X numbered 18a, Bank Y numbered 18b and Bank Z numbered 18c.

As is typical in conventional Internet transactions, the software is written in Java and resides on website 15. When a computer system of an authorized user logs onto website 15, the necessary computer program parts are down loaded onto the computer system of the user. Alternative, each participant can be provided with the requisite portions of the software to enable that participant to use the exchange.

Each computer system (not shown in detail) is conventional and can includes as a minimum: a general purpose digital computer, such as a microcomputer utilizing a microprocessor; a mass storage system in communication with the computer, such as a hard disk; software stored on the storage system; a data storage area on the storage system; input equipment such as a keyboard and mouse; output equipment such as a monitor, a printer; and communication hardware such as a modem or in larger systems an entire communications router which are connected to the Internet. Each of importer computer system 10, exporter computer system 12, issuing bank computer system 16, and confirming bank computer system 18 have appropriate software to connect to the Internet, to provide encryption, and to send and receive data to the transaction manager computer system 14. Tie transaction manager computer system 14 has the requisite computer software to perform the tasks stated below.

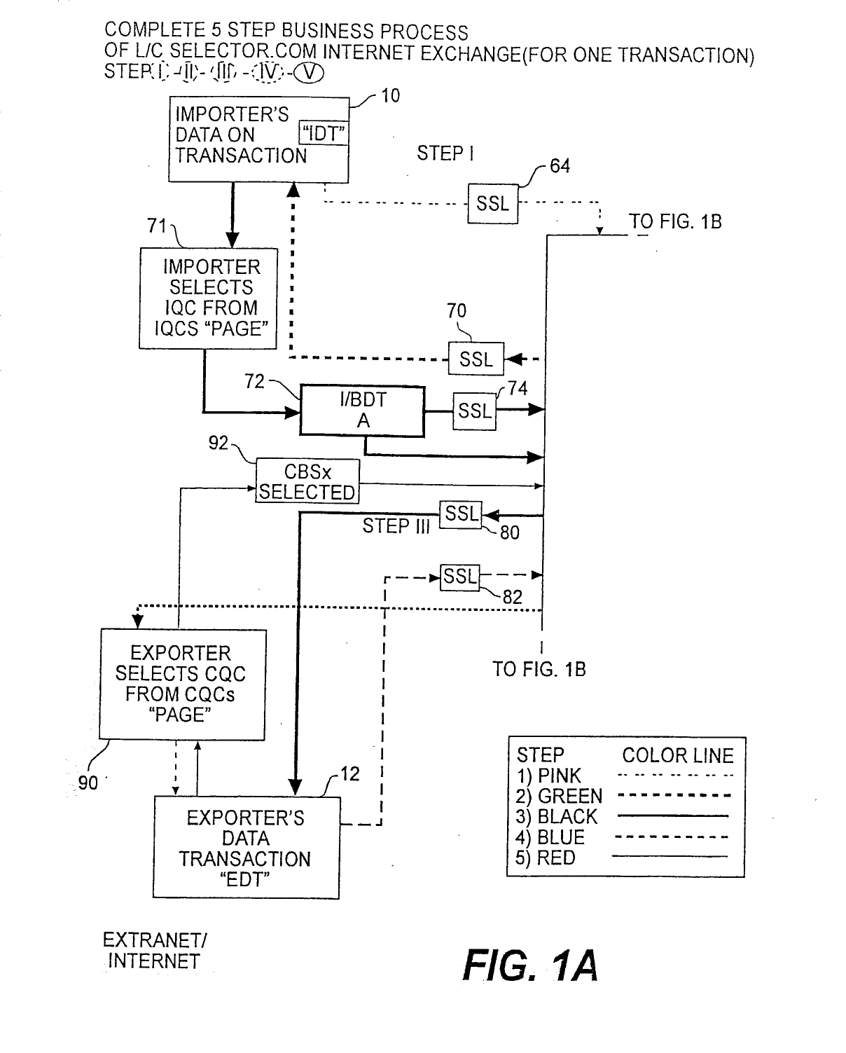

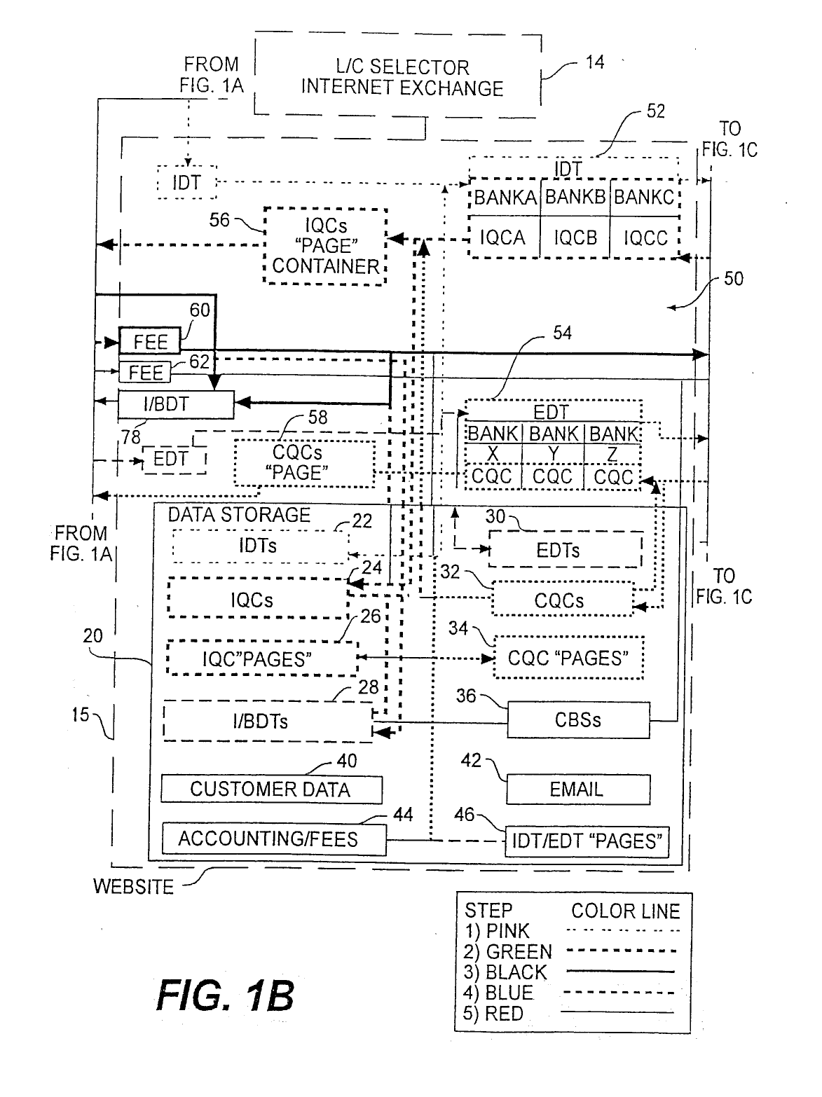

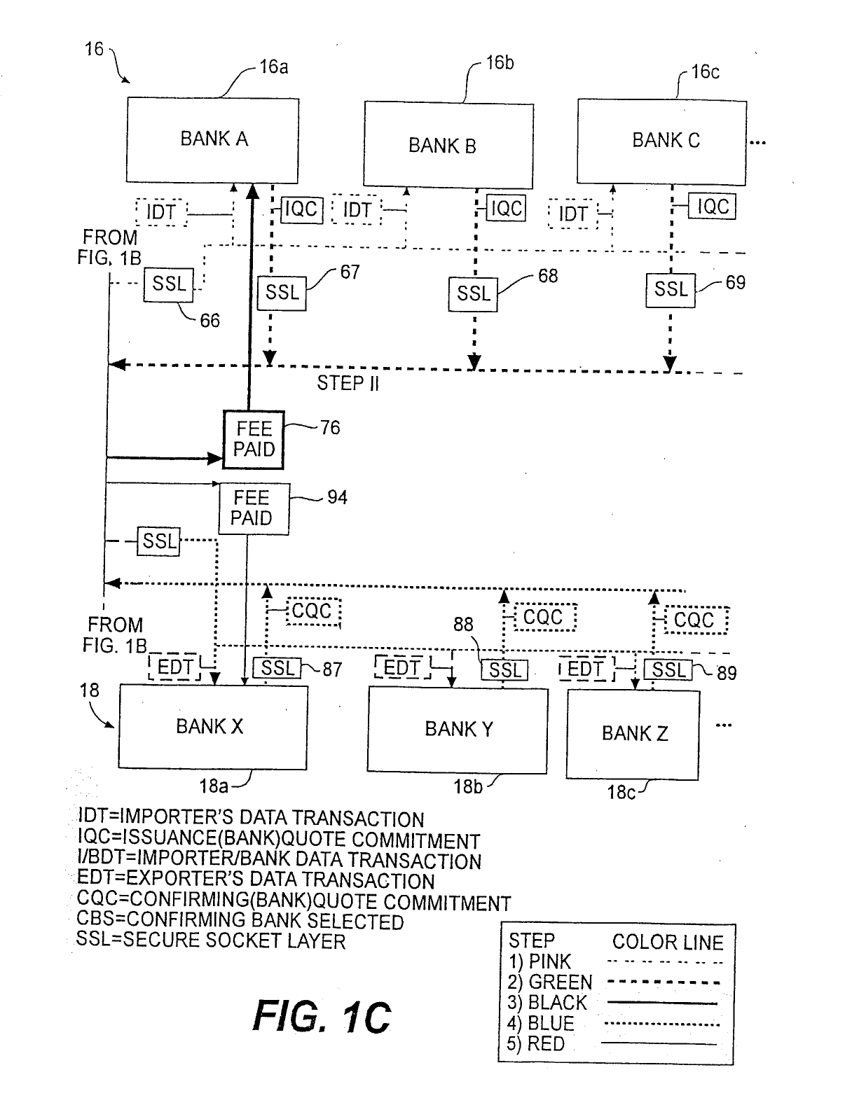

As is schematically shown in FIG. 1B, transaction manager computer system 14 includes a data storage or data base 20. Data base 20 is either part of website 15 as shown or can be separately stored in another computer system. Data base 20 includes a number of folders, each folder being schematically shown as being accessed during a different step of the process. These folders, which are more fully explained below, include for the importer's side: a plurality of IDTs folders 22; IQCs folders 24; ICQ “pages” folders 26; and I/BDTs folders 28. These folders for the exporter's side include EDTs folders 30; CQCs folders 32; CQC “pages” folders 34; and CBSs folders 36. In addition, data base 20 includes customer data folders 40; e-mail archive folders 42, 30 accounting and fee payment records in folders 44, and IDT/EDT “pages” in folders 46.

Also, schematically shown in website 15-above data base 15 in FIG. 1B is an open space portion which represents an active memory portion 50. In this active memory portion 50, central computer system stores active information about pending transactions, and calculates and assemblies information. These memory portions include an IDT memory portion 52 and an EDT memory portion 54. One third of IDT memory portion 52 is used to store importer's Data Transaction information being received by website 15 during Step 1 transactions and the other two thirds of which are used Go receive and assemble bids from issuing banks during Step 2 transactions. One third of EDT memory portion 54 is used to store exporter's Data Transaction information being received by website,15 during Step 3 transactions and the other two thirds of which are used to receive and assemble bids from confirming banks during Step 4 transactions. There is also an IQC Page Container portion 56 and a CQCs Page Container portion 58. Each of these container portions are used to assemble and store all valid bids from all bidding importing or confirming banks, respectively. Finally there are fee recordation portions 60 and 62 to calculate and store fees associated with the transaction for each of the issuing side and the confirming side of the transaction.

In the description of the flow chart, the following acronyms are used:

CBS=Confirming Bank Selected

CQC=Confirming (bank) Quote Commitment

EDT=Exporter's Data Transaction

I/BDT=Importer/Bank Data Transaction

IDT=Importer's Data Transaction

IQC=Issuance (bank) Quote Commitment

SSL=Secure Socket Layer.

Each transaction from and to a bank is encrypted and thus is conducted through a secure socket layer. In this way, one bank is unable to see or have access to the transactional information of another bank. This ensures that the bidding for the Letter of Credit, whether it is by an issuing bank or by a confirming bank, is truly secret. Thus, the preferred embodiment of the present invention is a blind bid. However, it is also within the scope of the present invention that a fully competitive bidding system is supported in which each issuing bank or confirming bank can see the bid of the other bidding issuing banks or confirming banks, respectively, and thereby decide whether to bid lower or not.

As stated above, a complete transaction usually has five steps. A summary of these steps, and with reference to the drawing the “color” of the flow lines are as follows:

Step 1, depicted by the “pink” line which is a series of sets of two dots per set, is the posting of a request for a Letter of Credit (LC) by the importer/buyer on the website of a transaction manager;

Step 2, depicted by the “green” line which is a series of short, thick dashes, is the posting of an offer or bid by one or more banks for issuing the LC;

Step 3, depicted by the “black” line which is a thick solid line, is the posting of the issuing bank selected by the importer;

Step 4, depicted by the “blue” line which is a series of dots is the posting of an offer by the exporter of a request for a proposal for confirming the offered LC; and

Step 5, depicted by the “red” line which is a thin solid line is the posting of the confirming bank selected by the exporter.

The individual steps will now be discussed in detail.

STEP 1.

Step 1 begins after an exporter and importer have made a deal involving the sale of goods in one country and the importation of those goods in a second country. A system according to the present invention now permits the transaction to go forward by providing a mechanism through which the contracting parties can locate two banks, one in the geographical location of the exporter and one in the geographical location-of the importer, who will issue and oversee an LC. Thus, step 1 begins with the posting of sales commitment information on website 15 and the solicitation of bids from an issuing bank or other source.

The typical transaction begins when an exporter or a group of exporters conclude sales commitments to sell goods and/or services to an importer or a group of importers who desire to buy and import into their country the goods and/or services. The sales commitments are usually embodied in a written or oral contract that includes as one of its terms the obtaining,of a Letter of Credit (sometimes referred to herein as an “LC”) by the importer from an issuing bank which usually deals only with the importer and the obtaining by the exporter of a performance confirmation by a confirming bank which usually deals only with the exporter. The contract sets the obligations for the payment of the issuing and confirming banks services, with the particular parties, although usually the importer is responsible for obtaining and paying for the LC and the exporter is responsible for obtaining and paying for a confirming bank. Up to this point in the transaction, all actions by the importer and the exporter are conventional.

The present invention is now used to secure the best terms for each of the parties. The exporter or importer logs onto website 15 of transaction manager computer system 14 The sale commitment information is then posted on website 15 by the importer and/or exporter. This sale commitment information includes the amount of sales commitment by currency; the type and quantity description of goods/services; the exporter's name and address; the importer's name and address; the terms of the sale which includes the payment terms, and the address of the to and from shipment addresses; the duration of the posting; and any other relevant transaction descriptions which are thought to be helpful in getting bids to be placed on website 15.

The path of Step 1, indicated by the “pink” lines, begins at Importer Computer System 10 in FIG. 1A, where the IDT information to be posted is encrypted, and proceeds through a secure socket layer SSL as indicated at 64 to website 15 (FIG.1B). Upon logging onto website 15, the IDT is stored in IDTs folders 22 of data base 15. The IDT is also made available to any participating issuing bank, called issuing bank candidates in Steps 1 and 2, such as issuing bank candidates 16a, 16b, and 16c, when they log onto website 15. The IDT is then sent encrypted by website 15 to a requesting bank through a secure socket layer, SSL 66, shown in FIG. 1C. This completes Step 1.

STEP TWO

Step two involves the collection of bids from one or more issuing banks by website 15, checking the bids to ensure that they are legitimate and are from participating banks or other institutions, reformatting the bids so as to present only certain information and present it in a predetermined way, and transmitting the bids to the importer. The bids are not shown to either the exporter or the other issuing or confirming banks.

Having received the IDT from website 15 in. Step 1, three issuing Bank candidates 16a, 16b and 16c have decided to place a bid, also called an issuance (bank) quote commitment or IQC, to issue an LC. Each bank candidate 16a, 16b, and 16c places an encrypted bid through respective secure socket layers 67, 68 and 69. Each bank making a bid has previously executed a contract with the transaction manager of website 15 and thus has qualified as a participating bank. The offer to issue an LC has committed each candidate issuing bank to an open sight LC at a particular fee charge, usually expressed as a percentage of the request amount of tie LC. In addition, a candidate issuing bank will usually state other conditions such as deposit requirements and the length of time the bid will be considered active.

The IQC bids are encrypted and sent to website 15 where they are stored in active IDT memory portion 52 until the time posted for receiving the bids has closed. Thereupon, they are assembled into an IQC “page” at container memory portion 56. At the same time the IQC page container information is being assembled, the IQC data is sent for permanent storage in IQCs and I/BDTs storage subdirectories or folders 24 and 28.

The path of Step 2, indicated by the “green” lines, begins at Bank Computer Systems 16a, 16b, and 16c in FIG. 1C, where these computer systems access website 15, find the requests for bids, select and make a bid. Banks A, B, and C make a bid by providing an Issuance (bank) Quote Commitment that is encrypted and sent to website 15 through a secure socket layer as indicated respectively in SSL boxes 67, 68 and 69. An IQC commits the bank to an open sight LC at a stated percent fee, and under terms and conditions they separately state. The bids from the three bidding banks are posted as either a “market” bid or a “limit” bid. A market bid is one that remains until either withdrawn or the importer has selected another LC issuer. This type of bid is useful because it may take several days, if not weeks, before the importer selects a bank. A limit bid is one that stays open only up to a stated time.

As stated above, at website 15, the bids are retained in IDT memory portion 52 until the time for bids expires, and then they are sent to IQC Page Container portion 56 where the bids are assembled into a page of formatted information and encrypted. From portion 56 the assembled bids are automatically sent in an e-mail to importer computer system 10 through a secure socket layer as indicated by SSL box 70. A copy of the e-mail is retained, as are all e-mail notifications by website 15 of transaction steps, in EMAIL archives 42.

This completes Step 2.

STEP 3.

In Step 3, the importer makes the desired selection of a bank and enters it into importer computer system 10. This is shown in FIG. 1A, by the “black” lines beginning at importer computer system 10 and proceeding as shown to an importer/bank data transaction box 71. Transaction box 71 in turn assembles and encrypts the selection as an importer/bank data transaction message, as shown in a message box 72.

From message box 72 the secure information is transmitted to website 15 through a secure socket layer, as shown in Van SSL box 74, FIG. 1A, for relay of the acceptance to Bank A computer system 16a. Also, a fee message is transmitted from message box 72 to fee recordation portions 60 (FIG. 1B) where a fee is recorded against the account of the importer for a successful transaction in obtaining an LC from a participating issuer bank.

In this example, the bid from bank A is selected and this is indicated by the choice in message box 72 and also by the notification path extending from fee recordation portions 60, across the page divide to a fee paid transaction box 76 of Bank A computer system 16a. Fee box 76 records a predetermined fee, usually in point, against the issuing bank A as a percentage of the LC and are paid to the transaction manager for the services of using website 15. The fees paid by importer 10 to Bank A for issuing an LC is based on the bid price and are paid outside of the present system.

Also, in Step 3, exporter computer system 12 is notified of the bid acceptance and issuance of an LC. In FIG. 1B, the acceptance notification is also sent from fee recordation portion 60 of website 15 to an importer/bank data transaction portion 78 where the information is stored during the present transaction. From transaction portion 78, the information is reformatted and encrypted and enters a secure socket layer as shown by an SSL box 80 in FIG. 1A. Flow then goes to exporter computer system 12. At this point Step 3 is finished.

STEP 4.

In Step 4, the process switches to the exporter obtaining a confirming bank and involves the posting of a request for bids and-the making of such bids by one or more confirming banks. However, the process can proceed only because an LC has been opened. The process will not proceed, and will be delayed at website 15, until the importer and an issuing bank have agreed on the terms of the LC and the bank has agreed to open one.

The process in STEP 4 begins at exporter computer system 12 where the exporter reviews the accepted LC and assembles its request to be posted on website 15. Exporter Computer System 12 also encrypts the information and sends it to the Internet as shown by the “blue” line, through a secure socket layer, as shown by SSL box 82. The flow of the exporter's data transaction (EDT) proceeds to website 15 and then is stored in EDTs folder 30 and made available on website 15 at EDT memory portion 54.

During their periodic search of website 15, or in another embodiment (not shown), upon specific, automatic notification by website 15 when the criteria from a participating confirming bank is reached. Thus Banks X, Y and Z having been informed about the posted LC confirmation solicitation, assemble their own bids or confirming (bank) quote commitment, and encrypt,them as shown by corresponding SSL boxes 87, 88, and 89. The CQC is then sent to and posted or retained in website 15 in the EDT memory portion 54 for temporary storage and sent to CQCs folders 32 for permanent storage. The banks X, Y and Z confirming LC bid is posted as either a “market” bid or a “limit” bid, which are the same as described above with respect to the issuing banks bids.

As soon as the time has closed for the receipt of bids, the received bids are packaged into a page by CQCs Page 58 and from there stored in CQC “pages” folders 34 and sent to exporter's data transaction computer system 12. This completes step 4.

STEP 5.

Step 5, the last step in the process, involves the selection of a bid by the exporter. The process flow is shown by the “red” line.

When the bids are received, as shown by process box 90 in FIG. 1A, the exporter will evaluate them and select one. This decision is effected and submitted by exporter's computer system 12 to website 15 as shown in process box 90 with Bank x having been selected, in this example, as seen in process box 92.

At website 15 the information is stored in CBSs folders 36 and transmitted to a fee recordation box 62 as shown in FIG. 1C. Fee box 62 records a predetermined fee, usually in point, against the confirming bank x as a percentage of the LC and are paid to the transaction manager for the services of using website 15. The fees paid by the exporter to Bank x for confirming an LC is based on a percentage of the LC and are paid outside of the present system.

This completes Step 5.

The present invention has now been described with respect to a specific embodiment thereof. However, modifications, substitutions and other changes can be made thereto without effecting the scope of the invention, which is set forth in the claims appended hereto.

I claim:

1. A method for obtaining a letter of credit opened by a buyer in favor of a seller and issued by an LC issuer and confirmed by an LC confirmer, the method comprising
posting of a request for a Letter of Credit (LC) by a buyer or a seller on a website of a transaction manager;
receiving on the website in a computer network a plurality of issuing bids by a plurality of issuers, one of the issuing bids to be selected by the buyer as a selected issuing bid;
receiving the selected issuing bid on the website;
posting of a request by the seller or the buyer for a confirmer to confirm an LC to be opened according to the selected issuing bid;
receiving on the website a plurality of confirming bids by a plurality of confirmers, one of the confirming bids to be selected by the buyer as a selected confirming bid; and
receiving the selected confirming bid on the website.

2. The method for obtaining a letter of credit as claimed in claim 1 and further including charging a buyer fee to the buyer and an issuer fee to the issuer who bid the selected issuing bid.

3. A method for obtaining a letter of credit as claimed in claim 2 and further including charging a seller fee to the seller and a confirming fee to the confirmer who bid the selected confirming bid.

4. A method for obtaining a letter of credit as claimed in claim 1 and further including charging a seller fee to the seller and a confirming fee to the confirmer who bid the selected confirming bid.

5. A system using a global computer network for obtaining a letter of credit (LC) opened by a buyer in favor of a seller and issued by an LC issuer and confirmed by an LC confirmer, the system comprising:
a manager computer system operated by a transaction manager, said manager computer system connected to the global computer system and including a server that manages a website, a communications device for sending outgoing messages on and receiving incoming messages from the computer network, and an encryption device that processes the outgoing and incoming messages, and software that permits the website to receive and post a request for a bid from an LC issuer and post a request for a bid from an LC confirmer, to format a plurality of bids from the LC insurer and the LC confirmer, to determine when a buyer and an LC issuer have agreed to the terms of issuing an LC and thereupon to charge each of the LC insurer and buyer a fee, and to determine when a seller and an LC confirmer have agreed to the terms of confirming an LC and thereupon to charge each of the LC confirmer and seller a fee;
a buyer computer system operated by the buyer and connected to the global computer network, said buyer computer system including a communication device that sends and receives messages to and from the global computer network, and software that permits the buyer to access the website and post a request thereon for the issuance of a letter of credit, to receive a plurality of formatted bids from the website, and to send an identification of a selected LC issuer to the website;
a seller computer system operated by the seller and connected to the global computer network, said seller computer system including a communication device that sends and receives messages to and from the global computer network, and software that permits the seller to access the website and post a request thereon for the services of an LC confirmer, to receive a plurality of formatted bids from the website, and to send an identification of a selected LC confirmer to the website;
an LC issuer computer system operated by the LC issuer and connected to the global computer network, said LC issuer computer system including a communication device that sends and receives messages to and from the global computer network, and software that permits the LC issuer to access the website and obtain a list of LC issuance requests and to send to the website a bid; and
an LC confirmer computer system operated by the LC confirmer and connected to the global computer network, said LC confirmer computer system including a communication device that sends and receives messages to and from the global computer network, and software that permits the LC confirmer to access the website and obtain a list of LC confirming requests and to send to the website a bid;
